(19) United States
(12) Patent Application Publication
(10) Pub. No.: US 2015/0169407 A1
(43) Pub. Date: Jun. 18, 2015

(54) METHOD AND SYSTEM FOR ERROR DETECTION AND CORRECTION IN APPEND-ONLY DATASTORES

(71) Applicant: DEEP INFORMATION SCIENCES, INC., Waltham, MA (US)

(72) Inventors: Thomas HAZEL, Andover, MA (US); Gerry BUTEAU, Durham, NH (US); David NOBLET, Londonberry, NH (US); Jason JEFFORDS, Bedford, NH (US)

(21) Appl. No.: 14/569,434

(22) Filed: Dec. 12, 2014

Related U.S. Application Data
(60) Provisional application No. 61/916,541, filed on Dec. 16, 2013.

(51) Int. Cl. G06F 11/10

(52) U.S. Cl. CPC G06F 11/1076; G06F 11/1004

(57) ABSTRACT

A method, system, and computer program product for error detection and correction in append-only data-stores. A user or agent input is received. Error detection and correction involving at least one datastore is begun based on the user or agent input. An error detection and correction state is created and error detection and correction is performed. A file sealing indication and/or a clean shutdown indication is interpreted, the error-detection and correction is ended, and the state of the error-detection and correction is written to memory in an append-only manner.

### CROSS-REFERENCE TO RELATED APPLICATION(S)

This application claims the benefit of U.S. Provisional Application Ser. No. 61/916,541, entitled “Method and System for Error Detection and Correction in Append-only Datastores” and filed on Dec. 16, 2013, which is expressly incorporated by reference herein in its entirety.

### BACKGROUND

1. Field

The present disclosure relates generally to a method, apparatus, system, and computer readable media for detecting and correcting errors in append-only datastores, and more particularly for representing append-only error detection and correction both on-disk and in-memory.

2. Background

Traditional datastores and databases are designed with log files and paged data and index files. Traditional designs store operations and data in log files and then move this information to paged database files, e.g., by reprocessing the operations and data. This approach has many weaknesses or drawbacks, such as the need for extensive error detection and correction when paged files are updated in place, the storage and movement of redundant information and the disk seek bound nature of in-place page updates.

### SUMMARY

In light of the above described problems and unmet needs as well as others, systems and methods are presented for providing transaction consistent error detection and correction both in-memory and on-disk. This is accomplished using the novel properties of append-only files to greatly simplify the error detection and correction process.

For example, aspects of the present invention provide advantages such as instantaneous shut down and start up times, asynchronous index creation and updates, greatly simplified transaction consistent error detection and correction including transaction roll-back and efficient use of storage resources by eliminating traditional logging and page files containing redundant information and replacing them with append-only transaction end state files and associated index files.

Additional advantages and novel features of these aspects of the invention will be set forth in part in the description that follows, and in part will become more apparent to those skilled in the art upon examination of the following or upon learning by practice thereof.

### BRIEF DESCRIPTION OF THE DRAWINGS

Various aspects of the systems and methods will be described in detail, with reference to the following figures, wherein:

FIG. 1 presents an example system diagram of various hardware components and other features, for use in accordance with aspects of the present invention;

FIG. 2 is a block diagram of various example system components, in accordance with aspects of the present invention; and

FIG. 3 illustrates a flow chart of transaction consistent detection and correction of errors in accordance with aspects of the present invention.

FIG. 4 illustrates a flow chart of receiving and processing header error detection requests in accordance with aspects of the present invention.

FIG. 5 illustrates a flow chart of receiving and processing header error correction requests in accordance with aspects of the present invention.

FIG. 6 illustrates a flow chart of receiving and processing header error detection and correction requests in accordance with aspects of the present invention.

FIG. 7 illustrates a flow chart of receiving and processing get last valid LRT Records

Location requests in accordance with aspects of the present invention.

FIG. 7A illustrates a flow chart of scanning fixed size LRT entries from the beginning of the file to determine the last valid record location in accordance with aspects of the present invention.

FIG. 7B illustrates a flow chart of scanning fixed size LRT entries from the end of the file to determine the last valid record location in accordance with aspects of the present invention.

FIG. 8 illustrates a flow chart of receiving and processing a LRT IsErred request in accordance with aspects of the present invention.

FIG. 9 illustrates a flow chart of receiving and processing a get last valid VRT record location request in accordance with aspects of the present invention.

FIG. 10 illustrates a flow chart of receiving and processing a scan for last valid VRT

Record location request in accordance with aspects of the present invention.

FIG. 11 illustrates a flow chart of receiving and processing a detect VRT error request in accordance with aspects of the present invention.

FIG. 12 illustrates a flow chart of receiving and processing a correct LRT/VRT error request in accordance with aspects of the present invention.

FIG. 13 illustrates a flow chart of receiving and processing a detect IRT error request in accordance with aspects of the present invention.

FIG. 14 illustrates a flow chart of receiving and processing a detect IRT segment error request in accordance with aspects of the present invention.

FIG. 15 illustrates a flow chart of receiving and processing a correct IRT error request in accordance with aspects of the present invention.

FIG. 16 illustrates a flow chart of receiving and processing an erase segment request in accordance with aspects of the present invention.

FIG. 17 illustrates a flow chart of receiving and processing a detect transaction log error request in accordance with aspects of the present invention.

FIG. 18 illustrates a flow chart of receiving and processing a correct transaction log error request in accordance with aspects of the present invention.

FIG. 19 illustrates a flow chart of receiving and processing an overall error detection and correction request in accordance with aspects of the present invention.

FIG. 19A illustrates a flow chart of detecting and correcting LRT/VRT/IRT group self consistency in accordance with aspects of the present invention.

FIG. 20 illustrates a flow chart of receiving and processing a detect frame data corruption request in accordance with aspects of the present invention.

FIG. 21 illustrates a flow chart of receiving and processing a shutdown request in accordance with aspects of the present invention.

FIG. 22 illustrates a flow chart of receiving and processing a seal file request in accordance with aspects of the present invention.

FIG. 23 illustrates a flow chart of receiving and processing a start up request in accordance with aspects of the present invention.

### DETAILED DESCRIPTION

These and other features and advantages in accordance with aspects of this invention are described in, or will become apparent from, the following detailed description of various example illustrations and implementations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of systems capable of providing representations of transactions for both disk and memory, in accordance with aspects of the present invention will now be presented with reference to various apparatuses and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented using a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example illustrations, the functions described may be implemented in hardware, software, firmware, or any combination thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), Electrically Erasable Programmable ROM (EEPROM), compact disk (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

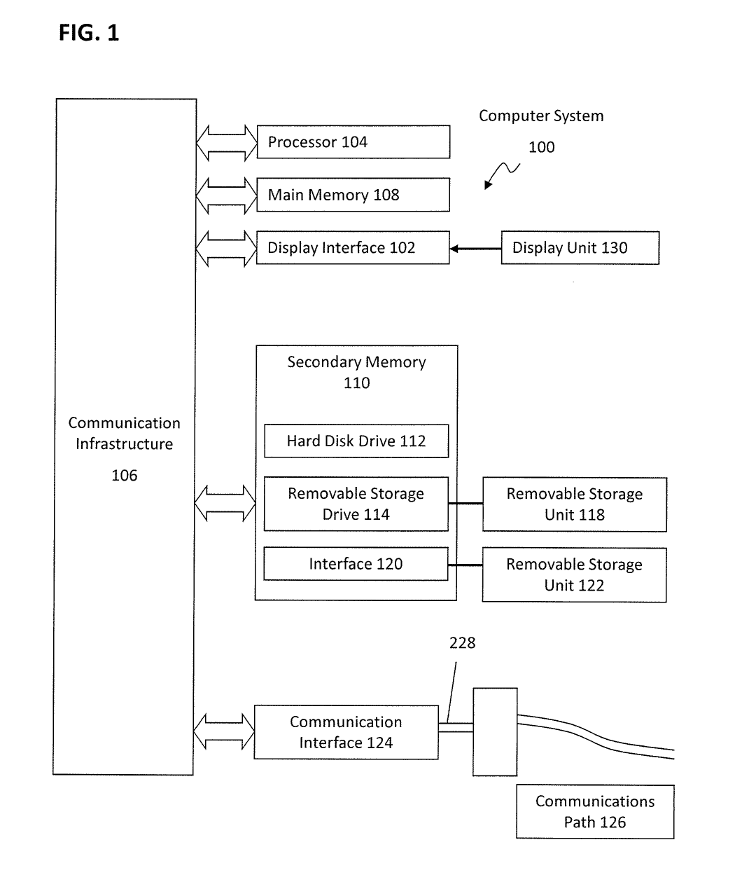

FIG. 1 presents an example system diagram of various hardware components and other features, for use in accordance with an example implementation in accordance with aspects of the present invention. Aspects of the present invention may be implemented using hardware, software, or a combination thereof, and may be implemented in one or more computer systems or other processing systems. In one implementation, aspects of the invention are directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software implementations are described in terms of this example computer system. After reading this description, it will become apparent to a person skilled in the relevant art(s) how to implement aspects of the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably RAM, and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative implementations, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an EPROM, or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100. Aspects of the invention are directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features in accordance with aspects of the present invention, as discussed herein. In particular, the computer programs, when executed, enable the processor 110 to perform various features. Accordingly, such computer programs represent controllers of the computer system 100.

In an implementation where aspects of the invention are implemented using software, the software may be stored in a computer program product and loaded into computer system 100 using removable storage drive 114, hard drive 112, or communications interface 120. The control logic (software), when executed by the processor 104, causes the processor 104 to perform various functions as described herein. In another implementation, aspects of the invention are implemented primarily in hardware using, for example, hardware components, such as application specific integrated circuits (ASICs). Implementation of the hardware state machine so as to perform the functions described herein will be apparent to persons skilled in the relevant art(s).

In yet another implementation, aspects of the invention are implemented using a combination of both hardware and software.

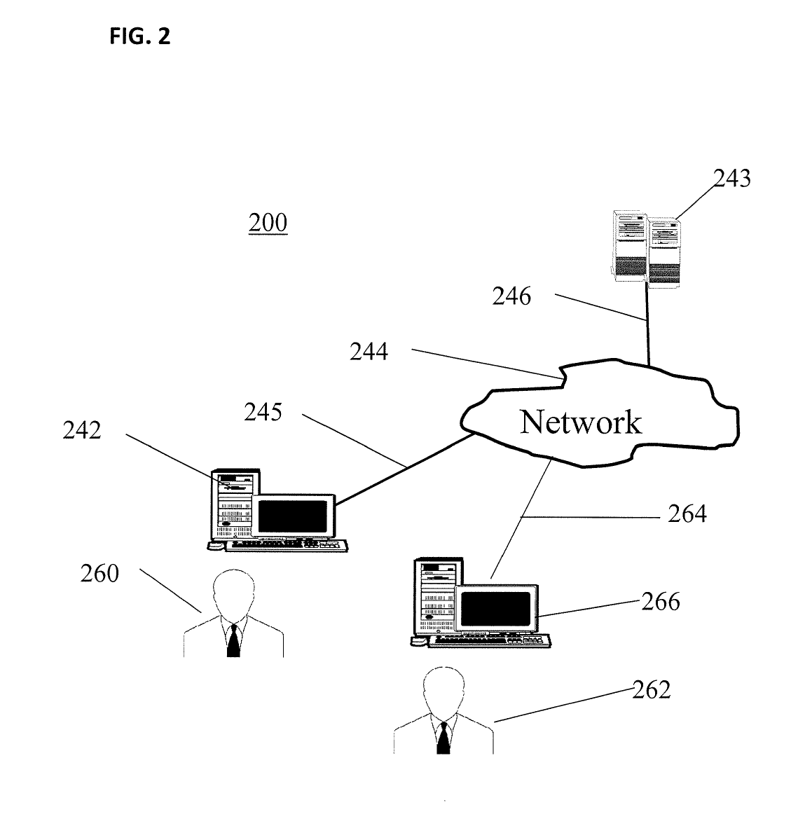

FIG. 2 is a block diagram of various example system components, in accordance with aspects of the present invention. FIG. 2 shows a communication system 200 usable in accordance with the aspects presented herein. The communication system 200 includes one or more accessors 260, 262 (also referred to interchangeably herein as one or more “users” or clients) and one or more terminals 242, 266. In an implementation, data for use in accordance with aspects of the present invention may be, for example, input and/or accessed by accessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links.

Transaction log, transaction state log, index files and schema may be written to disk in append-only mode, greatly increasing reliability and durability. However, greatly increased reliability and durability does not eliminate errors such as incomplete or inconsistent writes to disk. It also does not eliminate the possibility of data corruption errors within a file itself (e.g. a file is overwritten or corrupted by an external mechanism).

Thus, potential errors include three major classes of errors:
1. Incomplete writes to disk
2. Inconsistencies between information in two or more files
3. Data corruption within files

Aspects presented herein address potential sources of error, including each of these three classes of errors while simultaneously speeding startup and shutdown times.

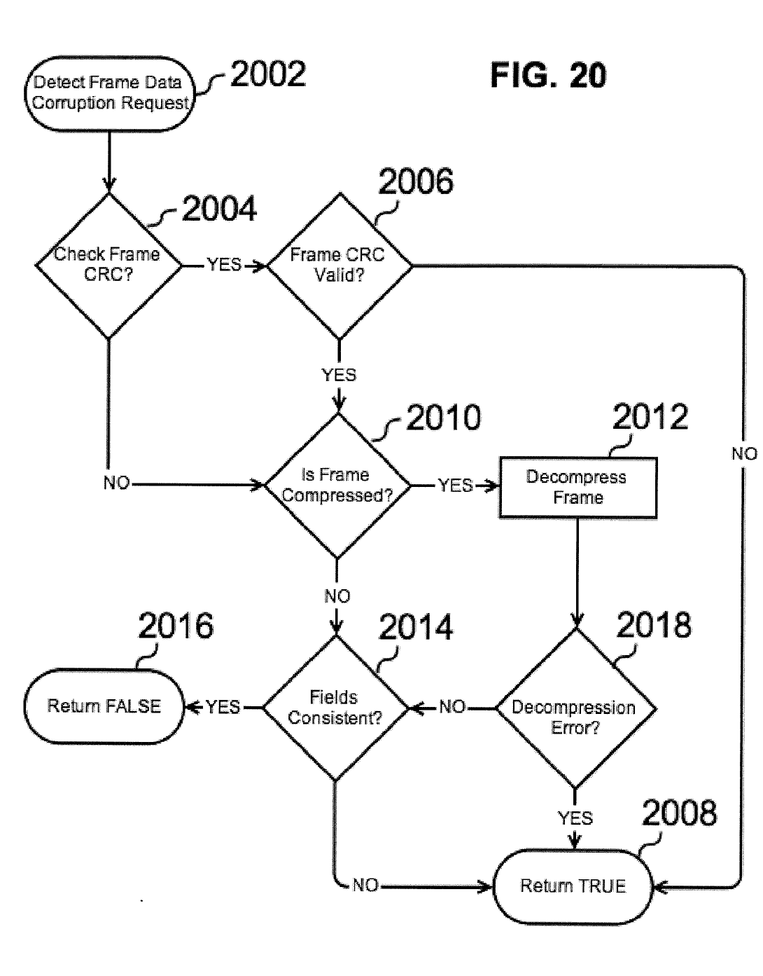

Files may need to be closed and/or archived and error correction and detection must take these events into consideration and converge quickly when they are detected. In this case, new Real Time Key Logging (LRT) files, Real Time Value Logging (VRT) files, and Real Time Key Tree Indexing (IRT) files can be created, and new entries may be written to these new files. An LRT file may be used to provide key logging and indexing for a VRT file. An IRT file may be used to provide an ordered index of VRT files. LRT, VRT, and IRT files are described in more detail in U.S. Utility application Ser. No. 13/781,339, filed on Feb. 28, 2013, titled “Method and System for Append-Only Storage and Retrieval of Information,” the entire contents of which are incorporated herein by reference. Performing error detection and correction requires an understanding of the type of files being processed and how the files are organized in storage, e.g., how the on-disk transaction log, state log, index and schema files are organized. An example logical illustration of file layout and indexing with an LRT file, VRT file, and IRT file is shown in FIG. 20A-20B of Utility application Ser. No. 13/781,339.

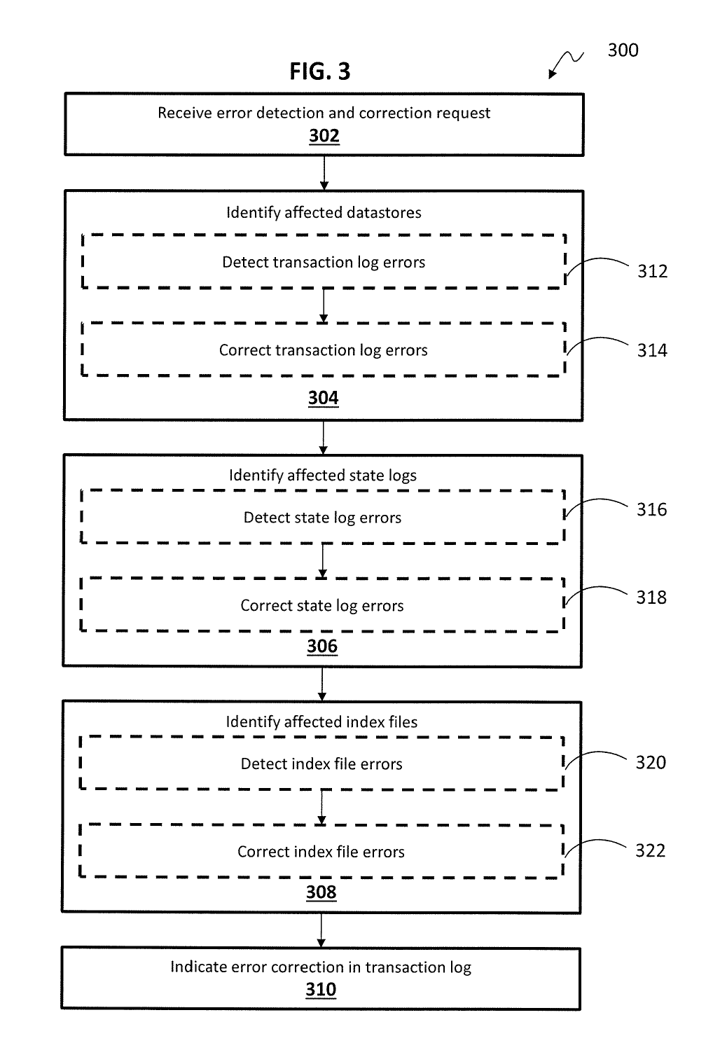

FIG. 3 presents a flow chart illustrating aspects of an automated method 300 of error detection and correction in append-only data-stores. Optional aspects are illustrated using a dashed line. At 302, input is received. This may be either user input or agent input. User input may be received, e.g., via a user interface. Such user input may include information identifying the datastores upon which error detection and correction should be performed.

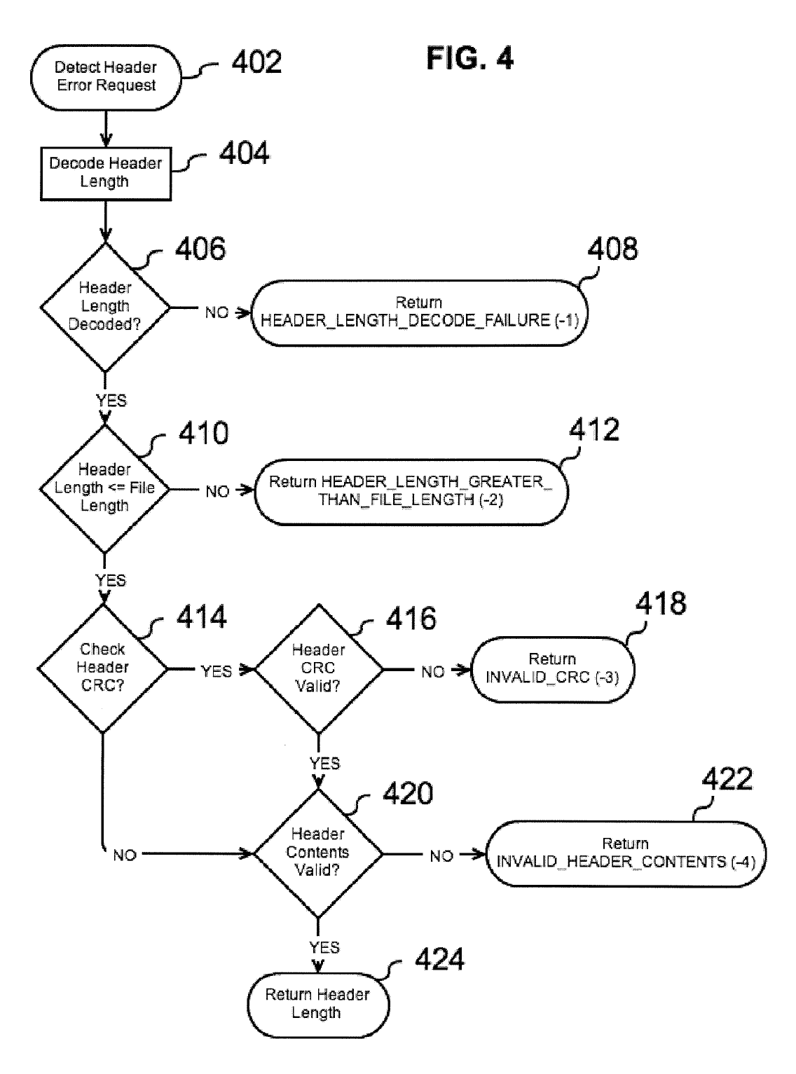

At 304, error detection and correction is begun, the error detection and correction involving at least one datastore based on the user or agent input. The datastore involved in the error detection and correction may have its associated transaction log checked for errors, as at 312. In addition, detected transaction log errors may be corrected at 314. Additional aspects of such detection and correction of transaction log errors are described in additional detail in connection with FIGS. 4, 5, 6, 17 and 18.

Affected state logs may be identified at 306. State log error detection may be performed at 316. State log error correction may be performed at 318. Additional aspects of such detection and correction of state log errors are described in additional detail in connection with FIGS. 4, 5, 6, 7, 7A, 7B, 8, 9, 10, 11 and 12.

Affected index files may be identified at 308. Index file error detection may be performed at 320. Index file error correction may be performed at 322. Additional aspects of such detection and correction of index file errors are described in additional detail in connection with FIGS. 4, 5, 6, 13, 14, 15, and 16.

The error detection and correction process is ended at 310, and the state of the error correction process is written to the transaction log in an append-only manner at 310, wherein the state comprises error detection and correction flags.

All LRT, VRT, and IRT files include a header. This header may contain errors. Thus, it may be beneficial to check a header for errors before additional error detection and correction is performed. Error detection may include checking for a properly formed header of the appropriate length and checking the header's Cyclic Redundancy Check (CRC), if one is present.

FIG. 4 is a flow chart illustrating aspects of an example automated method 400 of receiving a detect header error request in 402 and detecting header errors. At 404 the header length is decoded and at 406 it is determined whether the decode was successful. If the header length was not decoded as determined at 406, a header length decode error code is returned at 408. If the header length was successfully decoded, it is compared to the file length at 410. If the header length is not less than or equal to the file length a header length greater than file length error is returned in 412. If the header length is less than or equal to the file length, as determined at 410, a determination is made to check the header CRC at 414.

When the header CRC is to be checked, a determination of header validity may be made at 416. If the header CRC is not valid, as determined at 416, an invalid CRC error code is returned at 418.

When the header CRC is not checked, as determined at 414, or when the header CRC is determined to be valid at 416, a determination as to the validity of header contents is made at 420. If the header contents are not valid as determined at 420 an invalid header content error code is returned at 422, otherwise the header length is returned at 424.

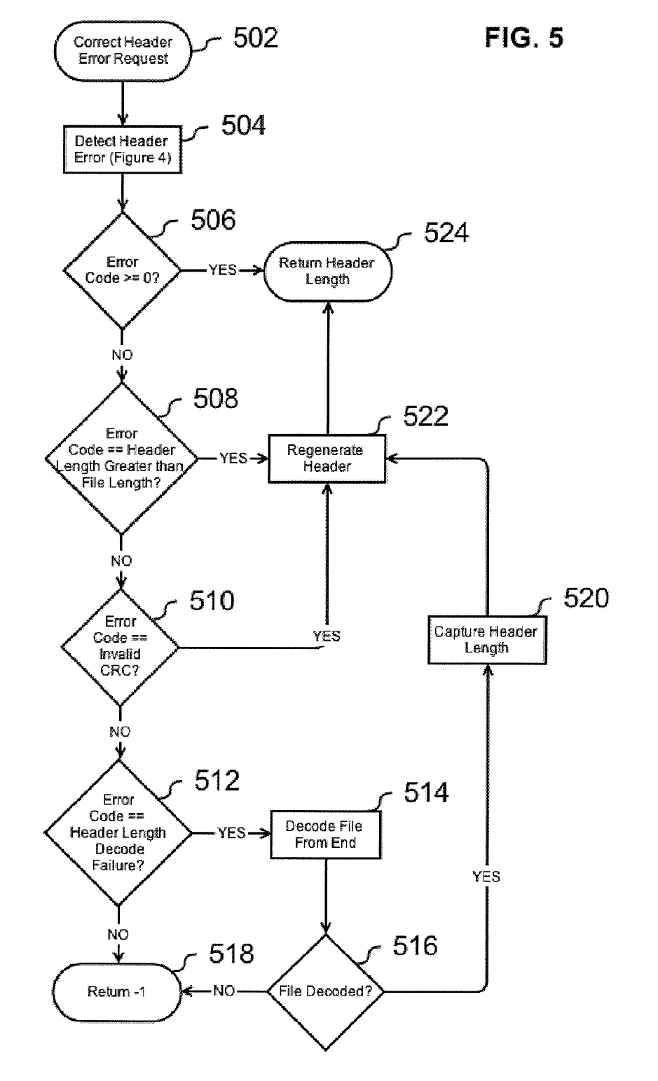

When a header has been determined to include an error(s) such header errors may be corrected, e.g., by header regeneration. FIG. 5 is a flow chart illustrating additional aspects of an example automated method 500 of receiving a correct header error request at 502 and detecting a header error at 504, which may be performed in connection with aspects of FIG. 4. If the Error Code obtained at 504 is greater than or equal to zero as determined at 506 there are no header errors to correct and the header's length is returned at 524.

When there are header errors to correct, as determined at 506, the header length is compared to the file length in 508. If the header length is greater than the file length, the header is regenerated at 522 and the header length is returned at 524. If there are header errors to correct, as determined at 506, the Error Code is checked in 508. If it is determined that the header length was greater than the file length, the header is regenerated in 522. Then, the regenerated header's length is returned in 524.

If the Error Code, as determined at 508, is not header length greater than file length, the Error Code is checked to determine if there is an invalid CRC in 510. If the error is an invalid CRC, as determined at 510, the header is regenerated in 522. Then, the regenerated header's length is returned in 524.

When the Error Code is not an invalid CRC, as determined at 510, the Error Code is checked in 512 to determine whether there was a header length decode failure. If there was no header length decode failure, an error condition is returned at 518. If there was a header length decode failure, as determined at 512, the file is decoded from its end in 514. If the file could not be decoded, as determined at 516, an error condition is returned at 518. If the file could be decoded, as determined at 516, the header length is captured at 520, the header is regenerated in 522 and the regenerated header's length is returned in 524.

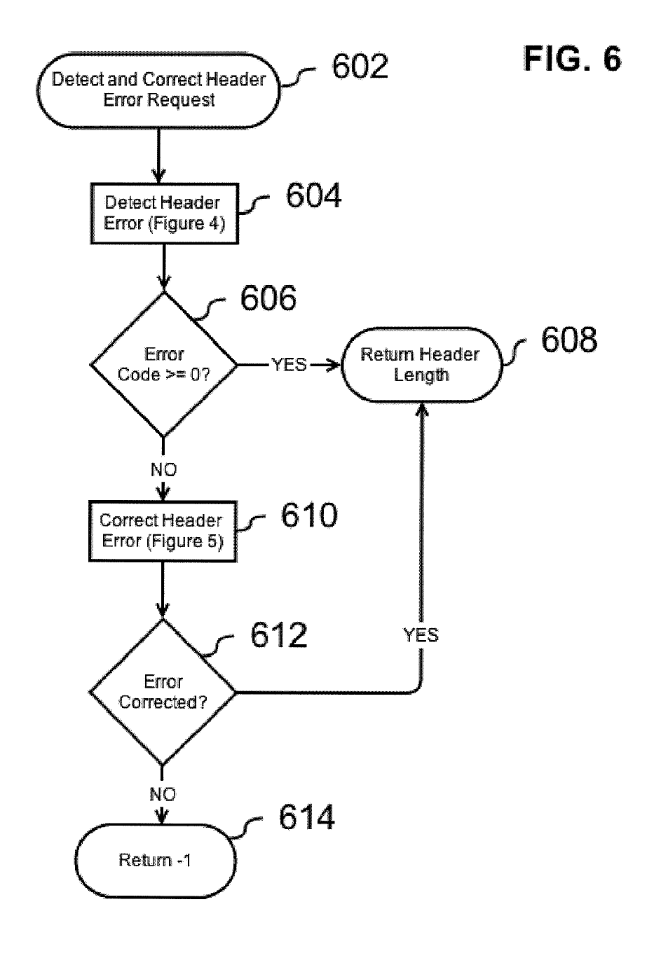

FIG. 6 is a flow chart illustrating additional aspects of an example automated method 600 of receiving a detect and correct header error request at 602 and detecting header errors at 604, which may be performed in connection with aspects described in FIG. 4. When the Error Code is greater than or equal to zero, as determined at 606, a determination is made that there are no header errors. Then, the header length is returned at 608. Otherwise, a determination is made that header errors exist that must be corrected in 610. Aspects described in connection with FIG. 5 may also be performed along with the flow chart of FIG. 6.

If the header errors are corrected in 610, as determined by 612, the header length is returned at 608. Otherwise the errors could not be corrected and an error indication is returned at 614.

Entries in LRT/VRT file pairs are written in lock-step. Each LRT entry maps to one, and only one, VRT entry. If the number of LRT entries is not equal to the number of VRT entries, or if the last entry in either or both files is not complete, there has been an incomplete record error.

Correcting the incomplete record error includes, e.g., its erasure from both the LRT and VRT files. Record erasure includes, e.g., the detection of the last complete record in each file. Once detected, the shortest run length of complete records from both files is chosen and all records after that point (complete or incomplete) are erased from both the LRT and VRT files. This process results in files with equal numbers of complete entries.

Record erasure may be performed by physically removing records from the file or by marking records as erased. Marking records as erased preserves the append-only invariant and provides a persistent indication of error detection and correction.

When group operations are being used (e.g. transactions or defragmentation) detecting and erasing incomplete records is necessary but may not be sufficient. In this case, incomplete groups must also be erased. Incomplete groups are deleted by scanning backwards from the last complete record until either a group end or a group start flag is reached (checking for group end first).

If a group end flag is reached this implies the records that followed were not part of a group operation. In this case the search stops and all records after the group end are erased. It is assumed records falling outside group boundaries are non-transactional and thus may be erased without data loss.

If a group start flag is reached this implies a group operation has lost its end and is incomplete. In this case all records after and including the group start flag are erased. This operation will result in data loss if the group operation represented a transaction. However, if the group operation represents a defragmentation operation, and the data contained within the defragmentation operation is still present in the LRT/VRT files (e.g. it is redundant information), there is no data loss.

Erasing records at the end of LRT/VRT files reduces the virtual length of those files. This new length provides an upper bound on value position encoded in IRT files. All changes after the last valid value position are rolled back by erasing all IRT segments containing value positions after the last value position indicated by the corrected VRT virtual file length. Once all error correction is performed the virtual file lengths are set to the real file lengths.

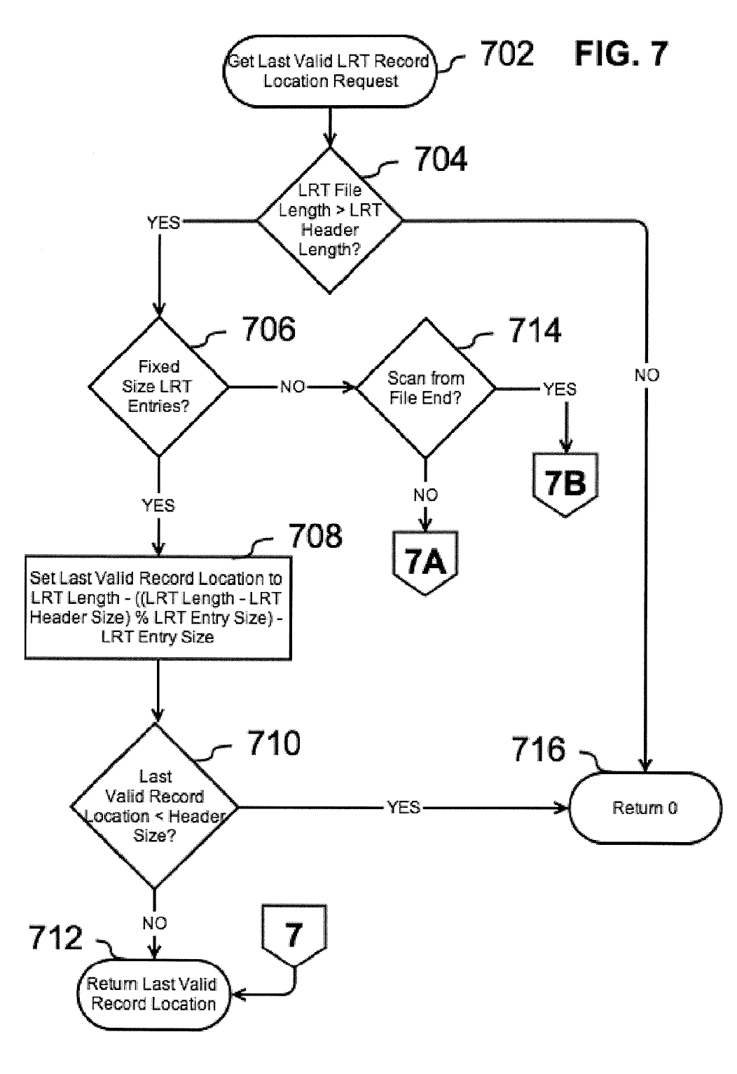

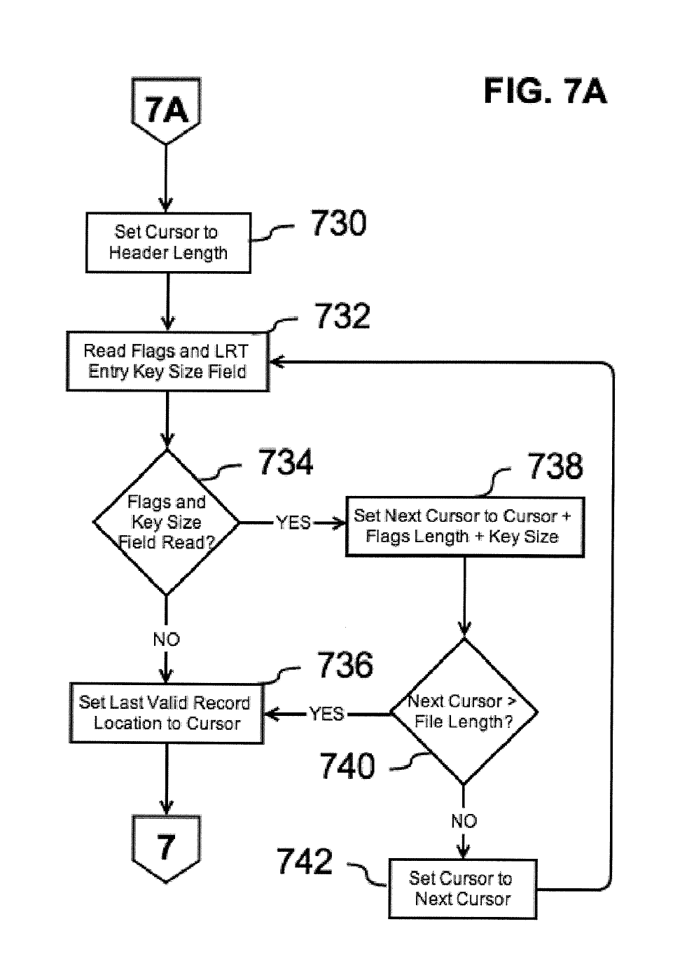

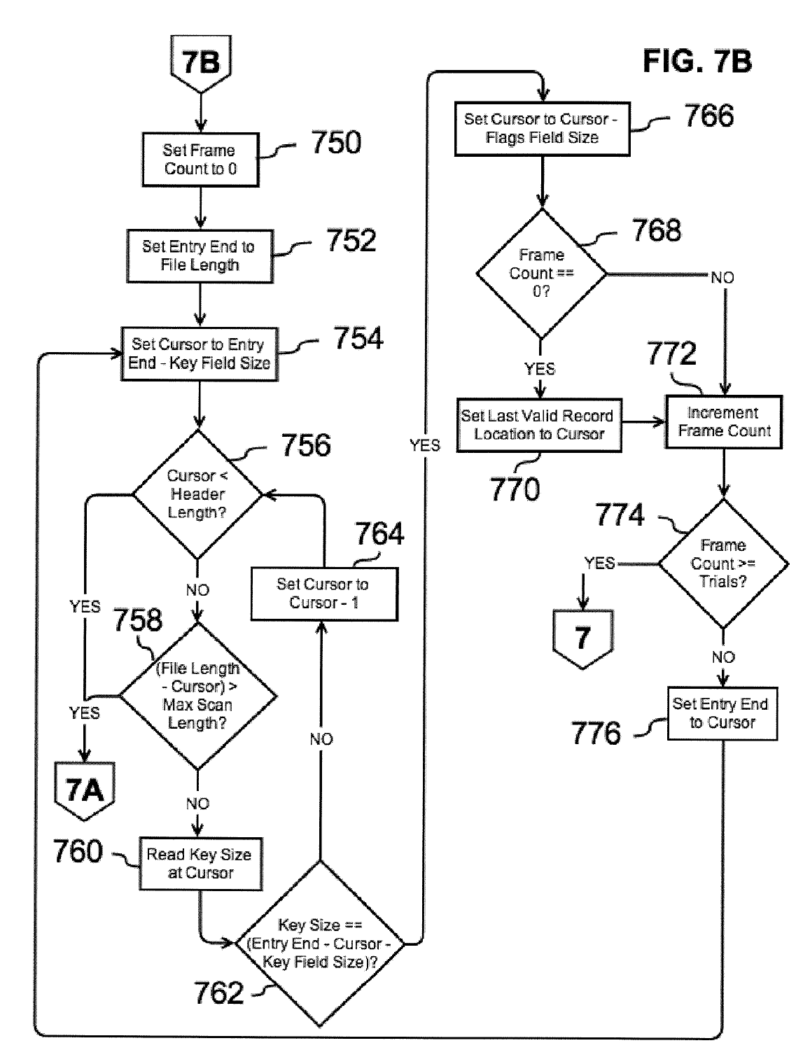

FIG. 7 is a flow chart illustrating aspects of an example automated method 700 of receiving a get last valid LRT record location request at 702 and determining if there are LRT records at 704. If the LRT file length is not greater than the LRT header length as determined at 704 there are no LRT entries and zero (indicating an error) is returned at 716.

When there are LRT records a determination is made as to whether the records are a fixed size at 706 and if the records are determined to be a fixed size, fixed size processing is performed to determine the last valid record location in 708. At 710 a determination is made as to whether the last valid record location that was calculated in 708 is less than the header size. If the last valid record location is determined to be less than the header size, zero (indicating an error) is returned at 716. When no error is present, as determined at 710, the last valid record location is returned at 712.

If LRT entries are not a fixed size, as determined at 706, a determination is then made as to whether the file should be scanned from its end at 714. If it is determined that the file should be scanned from its end, processing is continued at 750 in FIG. 7B. When the file is not scanned from its end as determined at 714, processing is continued at 730 in FIG. 7A.

FIG. 7A starts with the Cursor being set to the Header Length at 730, followed by reading the Flags and, then, the LRT Entry Key Size Field in 732. If the Flags and Key Size Field could not be read in 732, the Last Valid Record location is set to the Cursor. Then, processing continues in FIG. 7 at 712 where the Last Valid Record Location is returned.

When the Flags and Key Size Field can be read, as determined at 734, the Next Cursor is advanced to Cursor plus Flags Length plus Key Size in 738. If the next Cursor is greater than the File Length, the Last Valid Record Location is set to Cursor in 736. Then, processing continues in FIG. 7 at 712. Otherwise, the Cursor is set to Next Cursor in 724. Processing, then, continues at 732 where the next Flags and LRT Entry Key Size Field are read.

FIG. 7B starts with the Frame Count being set to zero in 750. After the Frame Count is set to zero the Entry End is set to the File Length at 752 and the Cursor is set to Entry End minus Key Field Size in 754. At 756 a determination is made as to whether the Cursor is less than the Header Length. When the Cursor is less than Header Length, as determined at 756, there are no additional entries to scan and processing continues at 730, in FIG. 7A, where the LRT is scanned from its beginning.

When the Cursor is not less than the Header Length as determined at 756 a determination is made as to whether the Max Scan Length has been exceeded at 758. If the Max Scan Length has been exceeded, processing continues in FIG. 7A where the LRT is scanned from its beginning. When the Max Scan Length has not been exceeded, as determined at 758, the Key Size is read at 760, and at 762 the Key Size is compared to Entry End minus Cursor minus Key Field Size to determine whether a frame has been detected. If the frame has not been detected at 762, the Cursor is rewound by one in 764. Then, processing continues at 756.

If a frame was detected at 762, the cursor is rewound to before the key Flags at 766 and the Frame Count is checked in 768 to determine if this is the first valid frame. If this is the first valid frame, the Last Valid Record Location is set to the Cursor in 770 and the Frame Count is incremented at 772.

When the Frame Count is non-zero, as determined at 768, a subsequent frame has been found, and the Frame Count is incremented in 772. Next, the Frame Count is checked at 774 to determine whether it is greater than or equal to the number of Trials required for valid framing detection. If valid framing has been detected at 744, processing continues in FIG. 7 at 712 where the Last Valid Record Location is returned. When the Frame Count is less than the number of trials, the Entry End is set to Cursor at 776 and frame detection continues at 754.

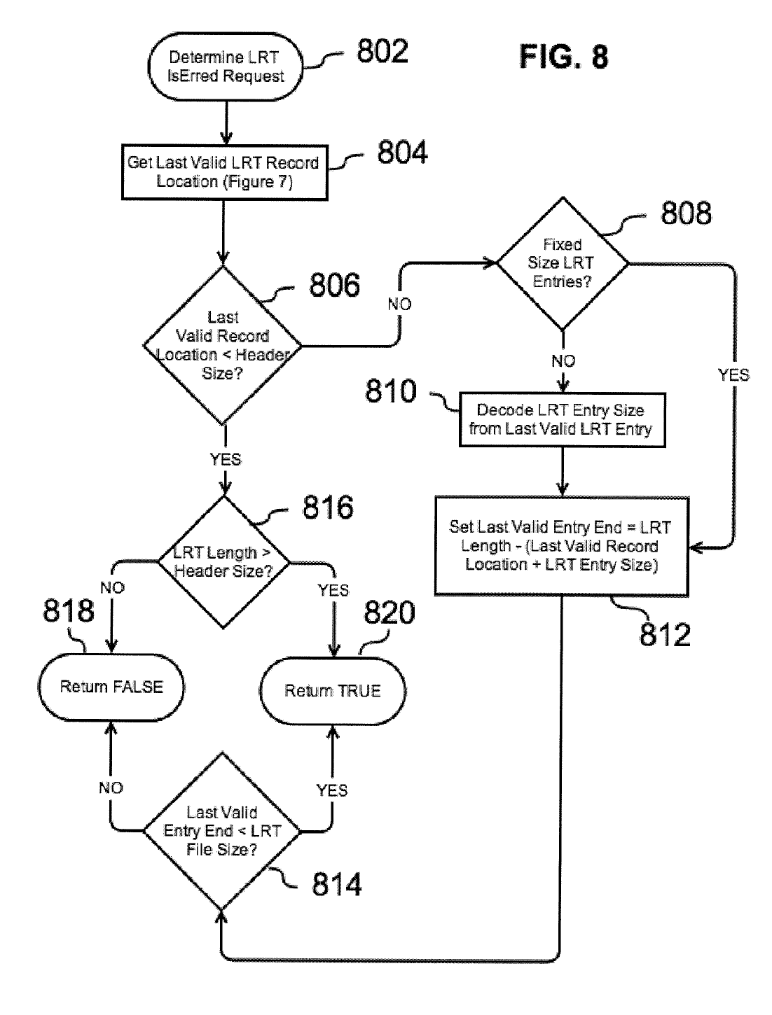

FIG. 8 is a flow chart illustrating aspects of an example automated method 800 of receiving a determine LRT IsErred request at 802 and getting the Last Valid LRT Record Location at 804. A determine LRT IsErred request is a request to determine if an LRT is erred. Additional details are described in connection with FIG. 7. At 806 the Last Valid Record Location is checked to determine whether it is less than the Header Size. When it is determined that the Las Valid Record location it is less than the Header Size, the LRT File Length is then checked to determine whether it is greater than Header Size at 816. When LRT length is greater then Header Size, as determined at 816, an error has been detected and TRUE is returned at 820. Otherwise, there is no error, and FALSE is returned at 818.

When the Last Valid Record Location is not less than Header Size, as determined at 806, a check is made to determine if the LRT Entries are of a fixed size at 808. When the LRT entries are not of a fixed size, the last valid entry's size is decoded from the last valid LRT entry in 810 and is set to LRT Entry Size. If LRT entries are of fixed size, as determined at 808, the LRT Entry Size is set to the known fixed size. In both cases, the Last Valid Entry End is set in 812 based on the LRT length minus the sum of Last Valid Record Location and LRT Entry Size.

Finally, if the Last Valid Entry End is less than the LRT File Size, as determined at 814, an error has occurred and TRUE is returned at 820. Otherwise there is no error and TRUE is returned at 818.

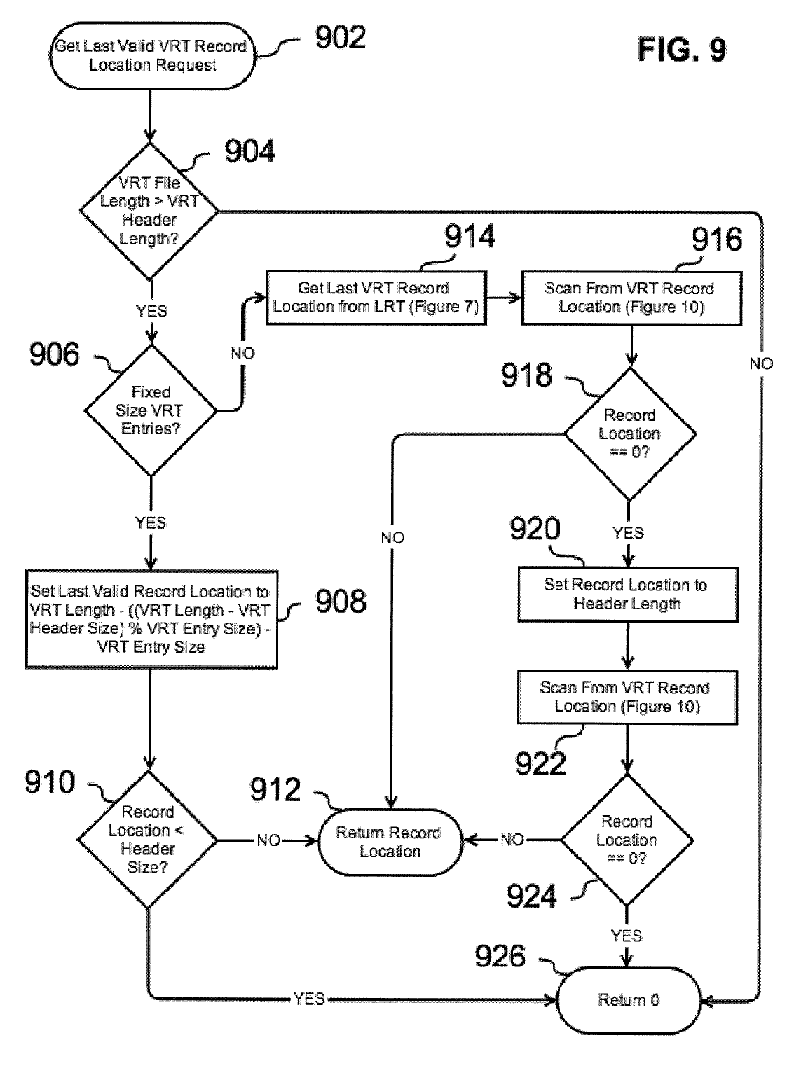

Similar to a request to get the last valid LRT record location, a request may be received to obtain the last valid VRT record location. FIG. 9 is a flow chart illustrating aspects of an example automated method 900 of receiving a get last valid VRT record location request at 902 and determining if the VRT File Length is greater than the VRT Header Length in 904. When the VRT File Length is not greater than the VRT Header Length, as determined at 904, there are no VRT records and zero is returned at 926.

When VRT File Length is greater than VRT Header Length, as determined at 904, a determination is made as to whether the VRT Entries are of a Fixed Size at 906. If the VRT Entries are of a fixed size, as determined at 908, the Last Valid Record Location is set to VRT Length minus any partial record bytes minus the VRT Entry Size in 908. At 910 the Record Location is checked against Header Size. If the Record Location is less than Header Size, an error has occurred and zero is returned at 926. When the Record Location is not erred, as determined at 910, the Record Location is returned at 912.

If VRT entries are not of a fixed size, as determined at 906, the Last VRT Record

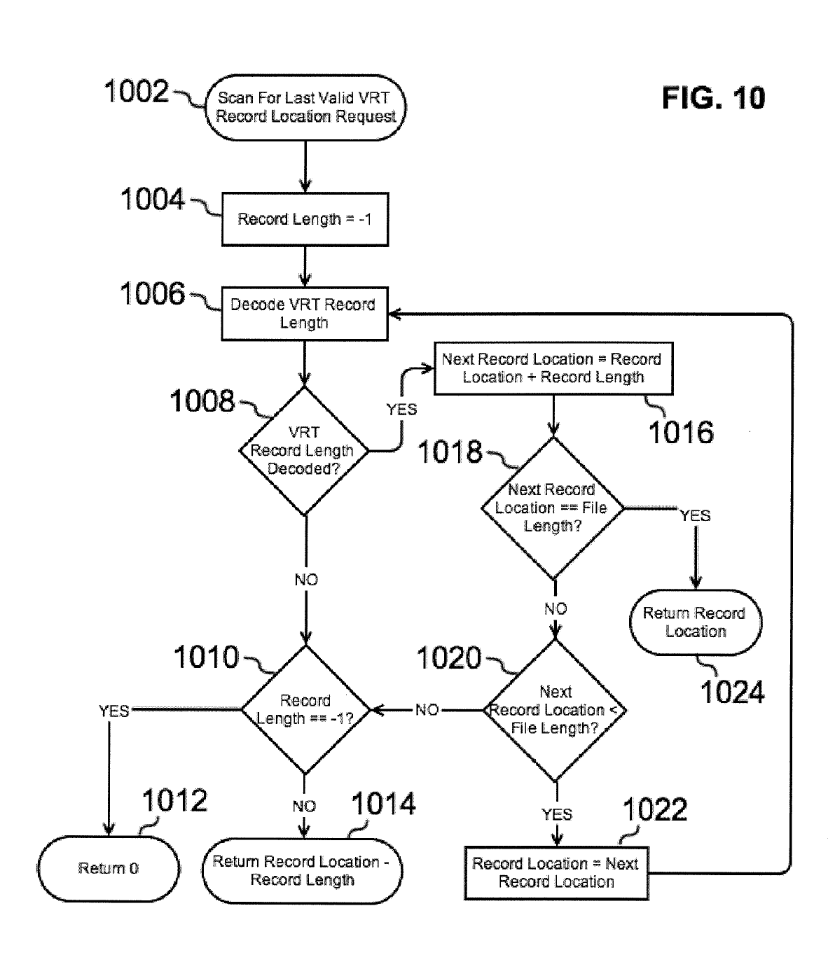

Location is retrieved from the LRT in 914. Additional details of such a retrieval are described in connection with FIG. 7. At 916 the VRT is scanned from the VRT Record Location retrieved from the LRT at 914. Additional details of such a scan are described in connection with FIG. 10. When the Record Location, as determined at 918, is not zero, the Record Location is returned at 912.

When the Record Location is zero, as determined at 918, the Record Location is set to

Header Length at 920 and the VRT is scanned from the Record Location in 922. Additional details of such a scan are described in connection with FIG. 10. If the Record Location is not zero, as determined at 924, the Record Location is returned at 912. Otherwise, an error has been detected and zero is returned at 926.

FIG. 10 is a flow chart illustrating aspects of an example automated method 1000 of receiving a scan for last valid VRT record location request at 1002. Once the request is received at 1002, the Record Length is set to negative one at 1004. Next, the VRT Record Length at the current Record Location is decoded at 1006. If a determination is made that the VRT Record Length was not decoded, as determined at 1008, the Record Length is compared to negative one in 1010. If the Record Length equals negative one as determined at 1010, an error has occurred and zero is returned at 1012. When the Record Length is not negative one the Record Location minus Record Length is returned at 1014.

When the Record Length is decoded, as determined at 1008, the Next Record

Location is set to Record Location plus Record Length at 1016. If the Next Record Location equals File Length, as determined at 1018, the Record Location is returned at 1024. Otherwise, the Next Record Location is checked to determine whether it is less than File Length at 1020. If it is determined that the Next Record Location is less than File Length, Record Location is set to the Next Record location at 1022. Thereafter, scanning continues at 1006. When the Next Record Location is not less than File Length, as determined at 1020, the end of the file has been reached and processing continues at 1010.

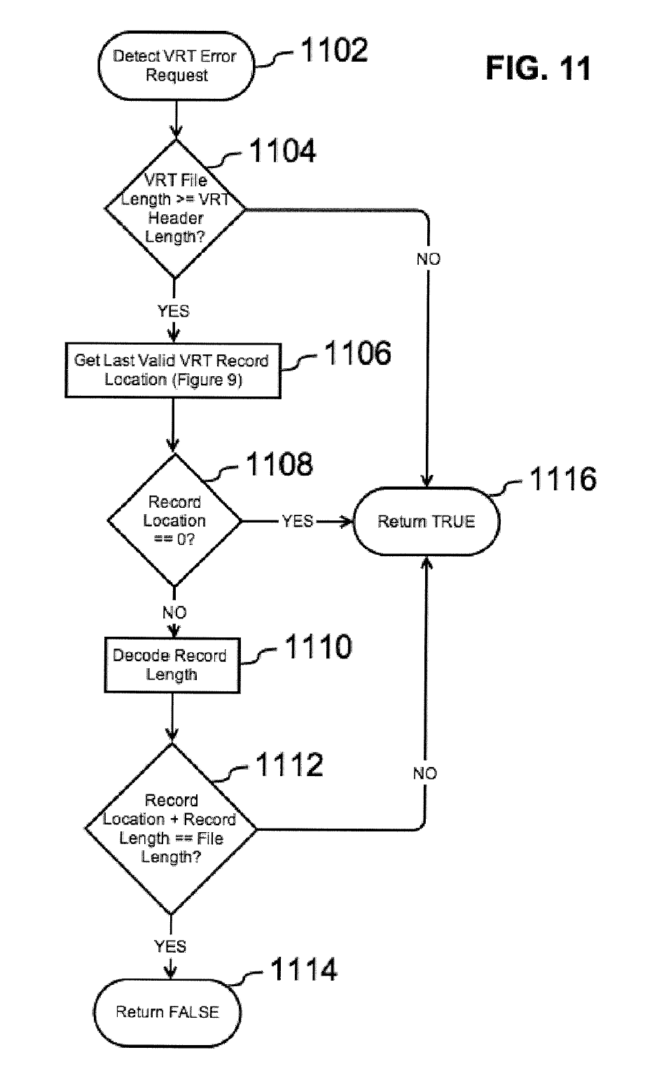

FIG. 11 is a flow chart illustrating aspects of an example automated method 1100 of receiving a detect VRT error request at 1102 and determining if the VRT File Length is greater than or equal to VRT Header Length at 1104. If the VRT File Length is not greater than or equal to Header Length, as determined at 1104, an error has occurred and TRUE is returned at 1116.

If the VRT File Length is greater than or equal to the VRT Header Length, as determined at 1104, the Last Valid VRT Record Location is calculated at 1106. Additional details of such a calculation are described in connection with FIG. 9. If the Record Location calculated at 1106 equals zero, as determined at 1108, an error has occurred and TRUE is returned at 1116. When the Record Location is non-zero, the Record Length is decoded at 1110. If the Record Location plus the Record Length is equal to File Length, as determined at 1112, no error has occurred and FALSE is returned at 1114. Otherwise, an error has occurred and TRUE is returned at 1116.

Once an error has been detected, a request may be received to correct the error. FIG.

12 is a flow chart illustrating aspects of an example automated method 1200 of receiving a correct LRT/VRT error request at 1202 and getting the Last Valid LRT Record Location in 1204. Additional details are described in connection with FIG. 7. If the Last Valid LRT Record Location is not zero, as determined at 1206, the LRT Record Length is decoded in 1208 and the Next LRT Record Location is set to the Valid LRT Record Location plus LRT Record Length at 1210. Next, the VRT Record Location is decoded from the LRT Record Location in 1212 and the VRT Record Length is decoded in 1214. Finally, the Next VRT Record Location is set to VRT Record Location plus VRT Record Length at 1216 and the process returns at 1218.

When the Record Location is equal to zero, as determined in 1206, the LRT File

Length is compared to the LRT Header Length in 1220. If the LRT File Length is less than LRT Header Length, the LRT File Header is regenerated in 1222. When the LRT File Length is greater than or equal to Header Length as determined at 1220 or after the LRT File Header is regenerated in 1222, the Next LRT Record Location is set to the LRT Header Length in 1224.

If the VRT File Length is less than the VRT Header Length, as determined at 1226, the VRT file header is regenerated at 1228 and the Next VRT Record Location is set to VRT Header Length in 1230. Thereafter, the process returns at 1218. When the VRT Header Length is greater than or equal to the VRT Header Length, as determined at 1226, the Next VRT Record Location is set to VRT Header Length at 1230. Then, the process returns at 1218.

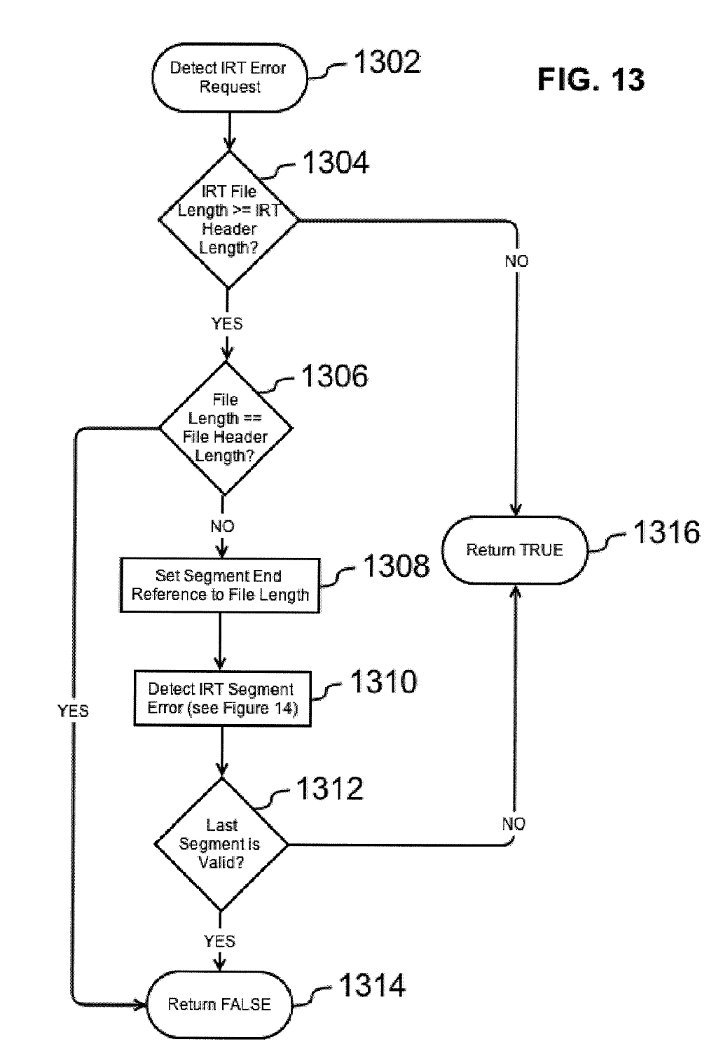

FIG. 13 is a flow chart illustrating aspects of an example automated method 1300 of receiving a detect IRT error request at 1302 and determining whether the IRT File Length is greater than or equal to the IRT Header length in 1304. If the IRT File Length is not greater than or equal to the IRT Header Length, as determined at 1304, an error has been detected and TRUE is returned at 1316. Otherwise, the File Length is compared to Header Length at 1306. If the File Length and Header Length are equal, error detection is complete and FALSE is returned at 1314.

When File Length is not equal to Header Length, as determined at 1306, the Segment

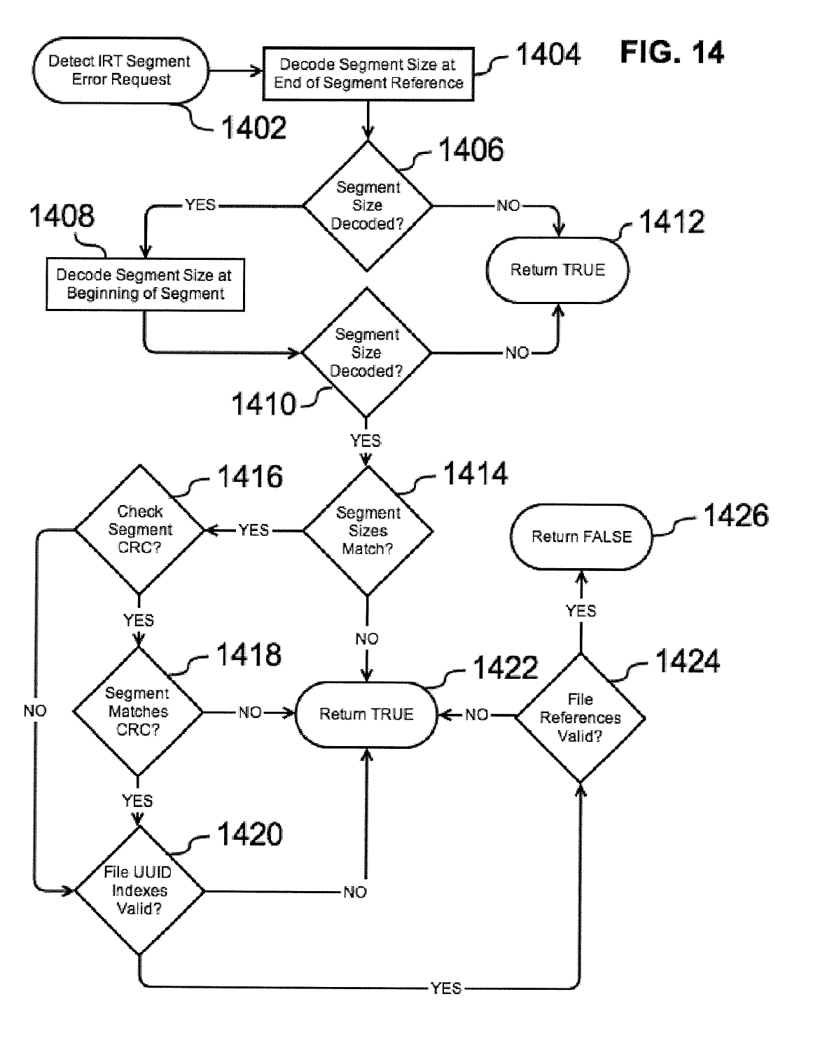

End Reference is set to File Length at 1308. Then, the IRT segment errors are detected at 1310. Additional details of such error detection are described in connection with FIG. 14. If the last segment is valid as detected at 1312, there is no error and FALSE is returned at 1314. Otherwise, an error has been detected at 1312 and TRUE is returned at 1316.

A IRT file may suffer an incomplete write. This error is detected by scanning for well-formed segments starting at the end of the IRT. A simple heuristic error checker can consider the following:

1) Segment size at the end of the segment and the beginning of the segment must be equal, if not there is corruption

2) If a per-segment CRC is present, it should be recalculated against the segment data and if it does not match there is an error

3) If segment sizes are equal the File UUID Index can be checked to determine if it references a valid file, if not there is an error

4) If the File UUID Index is valid, the Last Indexed Position can be checked to see if it falls within the indexed file, if not there is an error

The above process can be repeated for up to T successful trials where increasing T decrease the probability of false negatives (undetected errors). In other words, the larger T the more accurate error detection becomes.

When an erred IRT file is detected the error is corrected by scanning for complete segments. A complete segment scan can start at the beginning of the IRT file or at the end of the IRT file. Starting at the beginning of the file can assume aligned segments while starting at the end of the file requires a byte-by-byte scan for segment alignment.

The scanning process can use the full segment error detection process described above or can use a subset of error detection checks depending on speed and accuracy goals. For example, step 1 can be used until an error is detected, at which point the test can “back up” N segments and do steps 2-4 to ensure the integrity of the last N segments. Generally, only the last segment will be invalid due to an incomplete write.

Once the first invalid segment is detected all data from that point in the file to its end can be erased. This leaves only complete, valid segments in the IRT file.

Once error correction has been performed, the IRT file may have more or less segments than its associated LRT/VRT files based on the Last Indexed Position of its segments. This is the final error that must be detected and corrected. There are three possibilities:

1) The IRT has indexed more data than is now available in LRT/VRT files (because those files were erred and have been corrected)

2) The IRT file has indexed less data than is now available in LRT/VRT files—this is a “normal” case where the remaining IRT file index can simply be generated from the LRT/VRT files

3) The IRT file has indexed all data available in the LRT/VRT files—no further work needs to be done

When the IRT has indexed more data than is now available in the LRT/VRT (case 1 above), those indexes must be erased from the IRT file. Maintaining the append-only invariant requires the erasure of all segments after the earliest missing segment across all LRT/VRT files. This may erase valid indexes from the IRT from unaffected LRT/VRT files but this is OK as those indexes can and will be re-generated (case 2 above).

FIG. 14 is a flow chart illustrating aspects of an example automated method 1400 of receiving a detect IRT segment error request at 1402 and decoding the segment size at the end of segment reference in 1404. If the segment size was not decoded, as determined at 1406, an error has occurred and TRUE is returned at 1412. When the Segment Size is decoded, as determined at 1406, the segment size at the beginning of the segment is then decoded at 1408. If the segment size is not decoded, as determined at 1410, an error has occurred and TRUE is returned at 1412.

When the segment size is decoded, as determined at 1410, the decoded segments sizes are compared in 1414. If they do not match, an error has occurred and TRUE is returned at 1422. If the segment sizes match and a Segment CRC should be checked, as determined at 1416, the Segment CRC is checked in 1418. If the segment does not match the CRC, an error has occurred and TRUE is returned in 1422. Otherwise, the CRC is determined to be valid in 1418 or the Segment CRC did not need to be checked as determined at 1416 and the File UUID Indexes are validated at 1420. If the file indexes are not valid, as determined at 1420, an error has occurred and TRUE is returned at 1422.

When the File UUID Indexes are valid, as determined at 1420, the File References are validated in 1424, and when they are valid, FALSE is returned at 1426. If the file references are not valid, as determined in 1424, an error has occurred and TRUE is returned in 1422.

Once errors in the IRT have been detected, steps may be taken to correct the error.

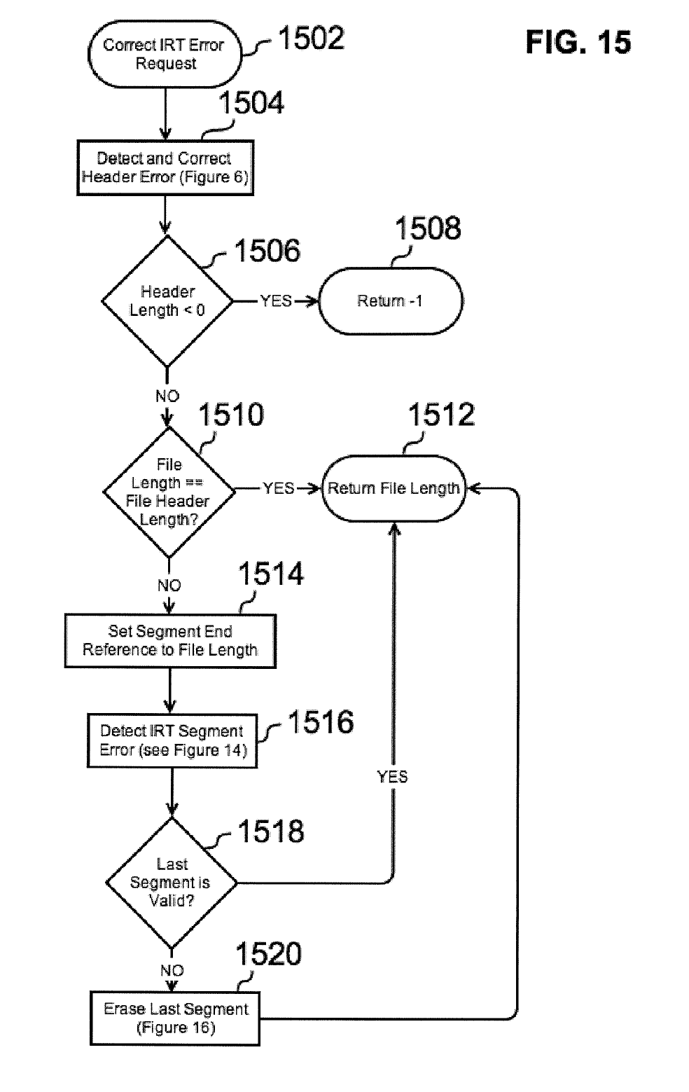

FIG. 15 is a flow chart illustrating aspects of an example automated method 1500 of receiving a correct IRT error request in 1502 and detecting and correcting header errors in 1504. Additional details are described in connection with FIG. 6. If the Header Length is less than zero, as determined at 1506, an error has occurred and negative one is returned in 1508.

When the Header Length is greater than or equal to zero, as determined at 1506, the

File Length is compared to File Header Length at 1510. If they are equal, the File Length is returned at 1512. When the File Length is not equal to the File Header Length, the Segment End Reference is set to File Length at 1514 and IRT segment errors are detected at 1516. Additional details are described in connection with FIG. 14.

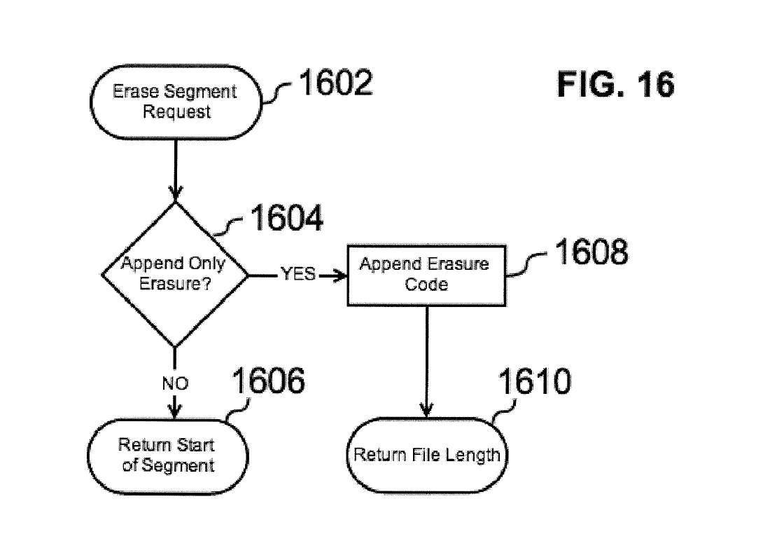

At 1518 a determination is made as to whether the last segment is valid. If the last segment is determined to be valid, the File Length is returned at 1512. When the last segment is not valid, as determined at 1518, the last segment is erased at 1520. Additional details are described in connection with FIG. 16. Once the last segment is erased in 1520, the file length is returned at 1512.

When the IRT has indexed more data than is now available in the LRT/VRT, those indexes must be erased from the IRT file. Maintaining the append-only invariant requires the erasure of all segments after the earliest missing segment across all LRT/VRT files. This may erase valid indexes from the IRT from unaffected LRT/VRT files. However, those indexes can be re-generated. FIG. 16 is a flow chart illustrating aspects of an example automated method 1600 of receiving an erase segment request at 1602 and determining if an append-only erasure is being performed as determined at 1604. If an append-only erasure is being performed as determined at 1604 an Erasure Code is appended at 1608 and the File Length is returned at 1610. When an append-only erasure is not being performed the Start of Segment is returned at 1606.

The transaction log file may suffer an incomplete write as well as containing incomplete or erred transactions due to errors and error correction in LRT and VRT files. This leads to at least two error correction phases: (1) correcting incomplete writes within the transaction log file, and (2) correcting incomplete/erred transactions with respect to LRT and VRT files. As the transaction log file includes fixed size records, incomplete writes may be detected simply by determining whether there are any partial records in the transaction log. This may be accomplished, e.g., using ((file length-header length) % record length) !=0.

When an incomplete record is detected that record is erased.

The transaction log file is processed from its end to determine if there are any incomplete transactions. This is accomplished by matching each transaction's begin, end and commit/abort entries until a No Outstanding Transactions flag is encountered in a commit/abort entry. Once the No Outstanding Transactions flag is encountered, any unmatched transactions are determined to be incomplete. Note, there may also be unknown transactions in the event of the loss of a large number records.

Incomplete transactions must be aborted if there is no chance for those transactions to completed (e.g. there was an incomplete write and/or process crash). This is accomplished, e.g., by:

1) Writing an Abort to the transaction log for each aborted transaction

2) Setting the No Outstanding Transactions flag in the last aborted transaction written

3) Ensuring the LRT and VRT files match the global transaction log and if they do not performing error correction on them and the transaction log (see below)

The final step in transaction log file error detection and correction, e.g., ensures its transactions match the information in the LRT and VRT files. Once LRT/VRT error correction has been performed those files may have less information than the transaction log indicates they should have. Conversely, once the transaction log's incomplete write errors are corrected it may contain less transactions than the LRT/VRT files indicate it should have. In both cases it is determined the transaction log does not match the LRT/VRT files and error correction must be performed.

When the transaction log does not match the LRT/VRT files all of the files may be analyzed to determine which transactions must be erased from the LRT/VRT files (if any) and aborted in the transaction log (if any). The following process may be used to determine which files must be modified:

1) Scan the transaction log file from its end

2) For each Start, End, Commit or Abort load the transaction details and record its state
1. Order each transaction by its start location within the transaction log
2. If any of the LRT entries within the transaction fall outside the LRT file, this transaction must be aborted if it has not been already, mark as abort
3. If all LRT files are represented within the transactions and are valid, stop processing the transaction log, otherwise continue at step 2

3) For each ordered transaction marked as abort
1. Write an aborted indication to the transaction log with the No Outstanding Transactions Flag set
2. Erase each LRT/VRT file indicated in the transaction to the start of transaction/group operation location

4) If any transactions were aborted, start over at step 1

At the end of the above process any incomplete transactions will have been marked as aborted in the transaction log and each LRT/VRT file will contain only successful transactions. Once complete, IRT files are adjusted to only contain valid LRT/VRT entries (see IRT error detection and correction above).

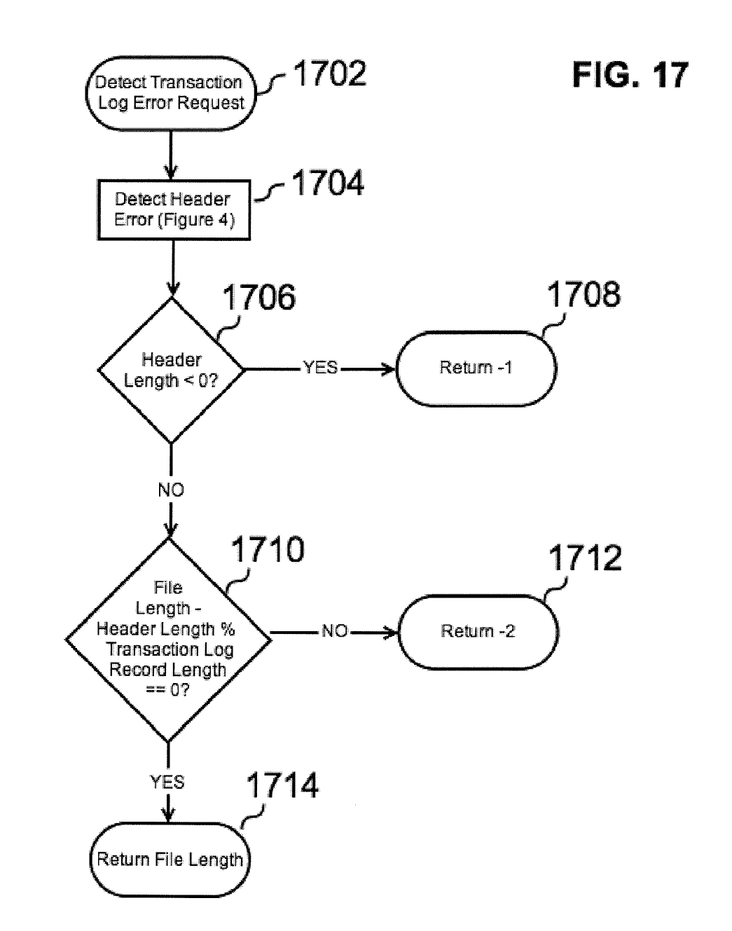

FIG. 17 is a flow chart illustrating aspects of an example automated method 1700 of receiving a detect transaction log error request at 1702 and detecting header errors at 1704. Additional details are described in connection with FIG. 4. If the Header Length is less than zero, as determined at 1706, an error has occurred and negative one is returned at 1708.

If the Header Length is greater than or equal to zero as determined by 1706 the transaction log is checked for incomplete records at 1710. If there are incomplete records, an error has occurred and negative two is returned at 1712. Otherwise, File Length is returned at 1714.

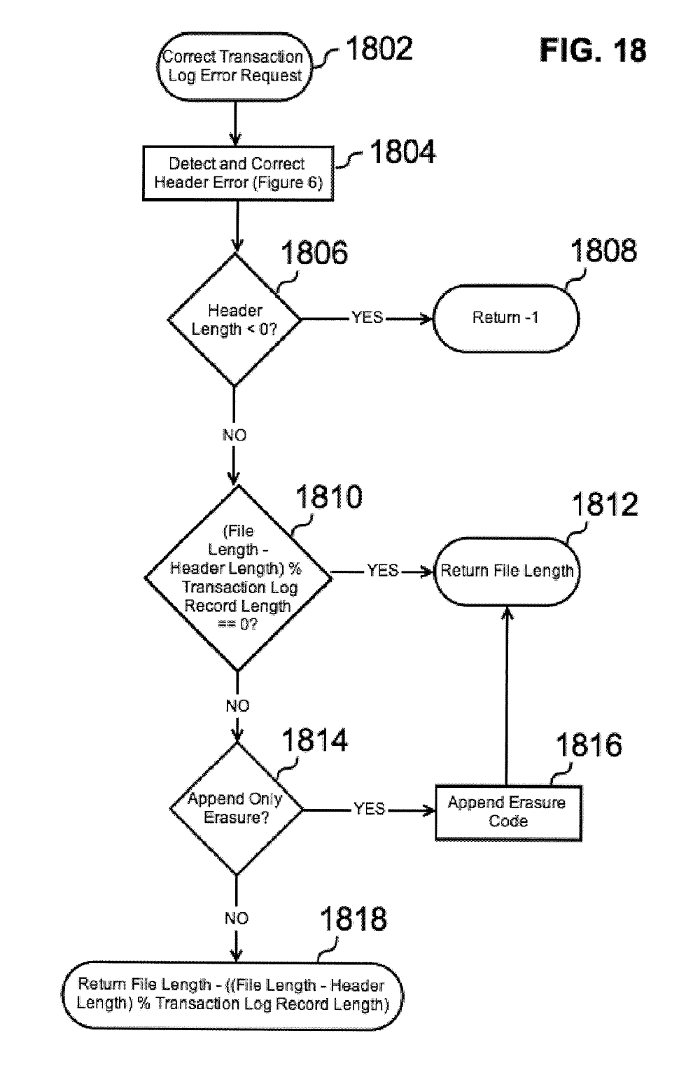

FIG. 18 is a flow chart illustrating aspects of an example automated method 1800 of receiving a correct transaction log error request at 1802 and detecting and correcting header errors at 1804. Additional details are described in connection with FIG. 6. If the Header Length is less than zero as determined at 1806, an error has occurred and negative one is returned at 1808.

If the Header Length is greater than or equal to zero, as determined by 1806, the transaction log is checked for incomplete records at 1810. If there are no incomplete records the File Length is returned at 1812. When incomplete records are detected at 1810, append only erasure is determined at 1814. If append only erasure is enabled, an erasure code is appended at 1816 and the File Length is returned at 1812. Otherwise, the last complete record and file length is calculated and returned at 1818.

As the different file types are dependent on the others, and as errors can occur in any of the files, it is important to ensure error correction in one file propagates to all other affected files. This may include, e.g., detecting and correcting incomplete record errors in all files and consistency checking between files. Detection and correction of incomplete record errors may include scanning the transaction log, LRTs, VRTs, and IRTs and correcting incomplete records. This may be localized to each file. It may be considered a file level consistency check. Once the files are internally consistent, consistency checking between files may be performed. Consistency checking between files may include ensuring that LRT/VRT file record counts match and correcting those that do not match, ensuring LRT/VRT and IRTs match and correcting those that do not match, and ensuring that transactions in the transaction log match all the corrected LRTNRT/IRT files and correcting those that do not match.

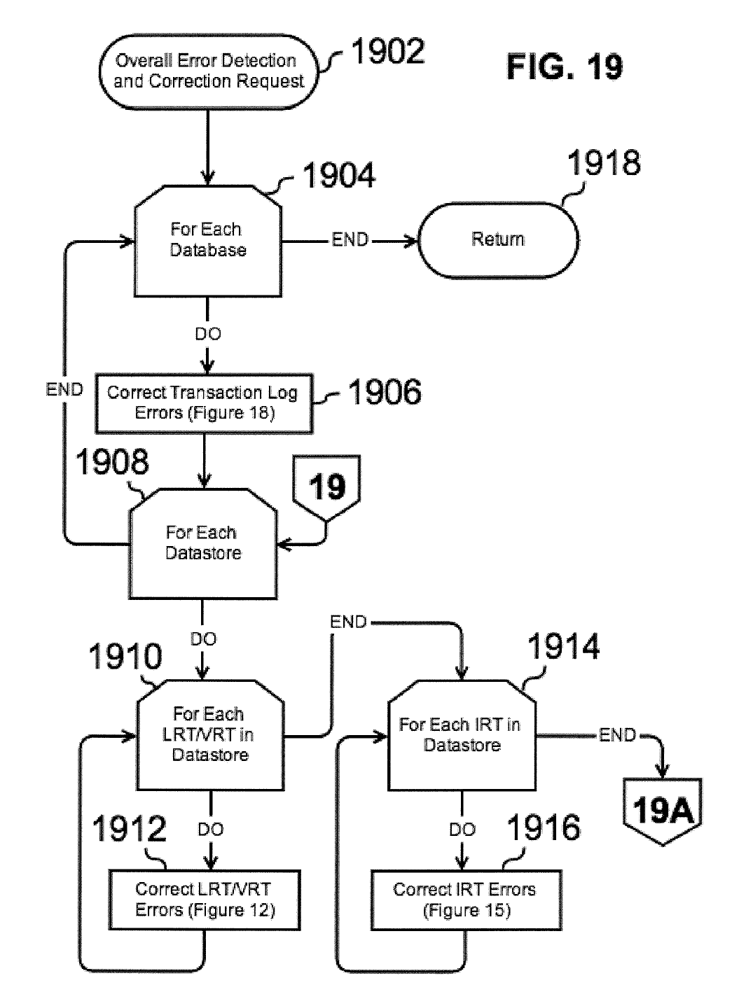

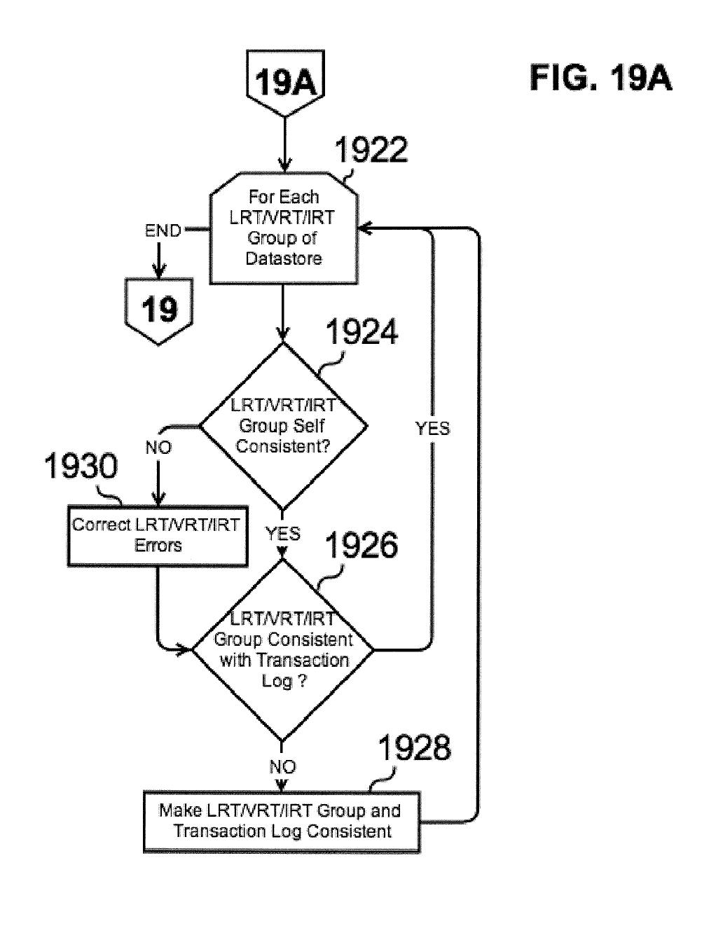

FIG. 19 is a flow chart illustrating aspects of an example automated method 1900 of receiving an overall error detection and correction request in 1902, iterating over each database in 1904 and ending the iteration over databases at 1918. Each database iterated over has its transaction log errors corrected at 1906. Additional details are described in connection with FIG. 18.

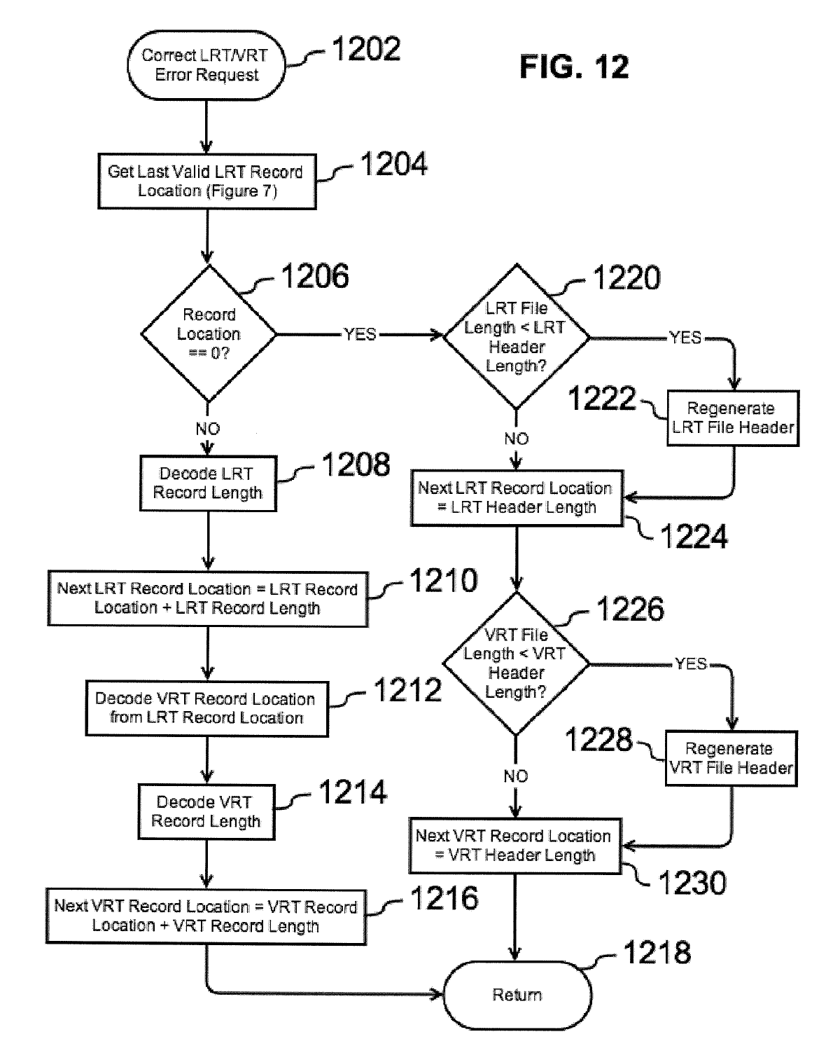

After transaction log errors are corrected in 1906, each datastore contained by the database is iterated over at 1908 with the iteration ending at 1904. During each iteration each datastore's LRT/VRT file pairs are iterated over in 1910 and LRT/VRT errors are corrected in 1912. Additional details are described in connection with FIG. 12. Once all LRT/VRT pairs have been iterated over in 1910 each IRT in the datastore is iterated over in 1914 and IRT errors are corrected in 1916. Additional details are described in connection with FIG. 15.

Once each IRT has been iterated over in 1914, processing continues at 1922 where each LRT/VRT/IRT group is iterated over and LRT/VRT/IRT groups are checked for self-consistency in 1924. When groups are not self-consistent, the LRT/VRT/IRT errors are corrected at 1930. Once the LRT/VRT/IRT group is self consistent it is checked for consistency with the transaction log at 1926.

When the LRT/VRT/IRT group is not consistent with the transaction log as determined at 1926 the LRT/VRT/IRT group and transaction log are made consistent at 1928 and iteration continues at 1922. If the LRT/VRT/IRT group was consistent with the transaction log as determined at 1926 iteration continues at 1922. When LRT/VRT/IRT group iteration is complete datastore iteration continues at 1908.

Data corruption is detected, e.g., using heuristics, file framing and checksums. Heuristics may be used mainly to check the internal consistency of known fields, e.g., flags, segment start, segment end, etc.. File framing, e.g., group start/end, segment start/end, provides natural boundaries for frame compression and frame checksums.

When frame compression is used, decompression operations may detect corruption, e.g., fail decompression. Additionally, frame checksums detect frame corruption in both compressed and uncompressed cases.

FIG. 20 is a flow chart illustrating aspects of an example automated method 2000 of receiving a detect data frame corruption request at 2002 and determining whether a Frame CRC must be checked at 2004. When the frame CRC must be checked, the Frame CRC is validated at 2006. When the Frame CRC is not valid, an error has occurred and TRUE is returned at 2008. When the Frame CRC is not checked as determined at 2004, or if the Frame CRC has been validated at 2006, processing continues at 2010 where the frame is checked for compression.

When the Frame is compressed, as determined at 2010, the frame is decompressed at 2012. If a decompression error occurs, as determined at 2018, TRUE is returned at 2008. If the frame is not compressed, as determined at 2010, or the frame was successfully decompressed, as determined at 2018, the consistency of the frame's files are checked at 2014. If the fields are consistent, as determined at 2014, the frame is not corrupt and FALSE is returned at 2016. If the fields are not consistent, as determined at 2014, there is an error and TRUE is returned at 2008.

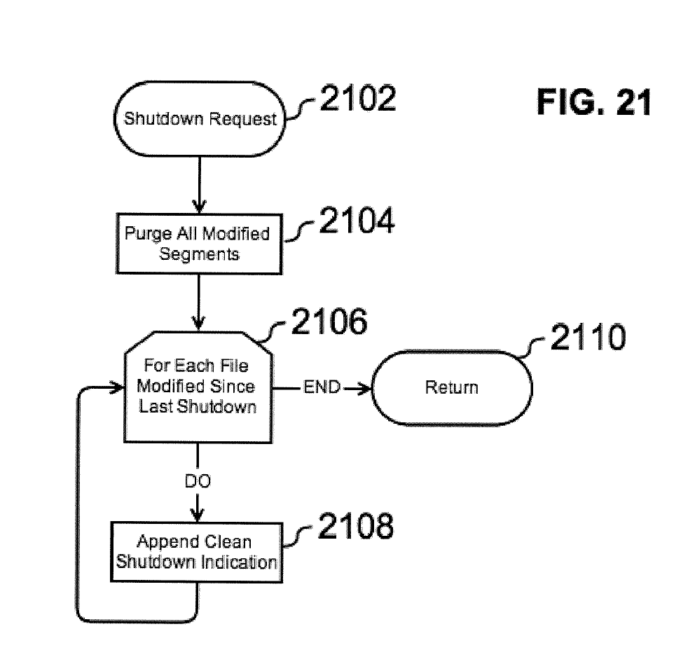

FIG. 21 is a flow chart illustrating aspects of an example automated method 2100 of receiving a shutdown request at 2102 and purging all modified segments at 2104. After modified segments are purged, each file modified since the last shutdown is iterated over in 2106 and a clean shutdown indication is appended at 2108. Once all modified files are iterated over in 2106 the process returns at 2110.

Among other times, error detection and correction can be performed on system startup. The algorithms presented herein enable fast detection and correction when a system is interrupted unexpectedly. When a system is shut down cleanly, start up convergence can be accelerated by appending an indication of a clean shutdown to modified files at the time that the clean shutdown is performed. Additionally, sealed files can have a sealed indication appended to them. This indication enables rapid convergence when performing error detection and correction. Appending clean shutdown and/or sealed indications to each file enables a greatly simplified error detection, and therefore, rapid convergence on system start up. Clean shutdown and sealed indications may also be extended to include additional information used to reduce convergence times for additional operations, e.g., count, cardinality calculation, indexing, etc.

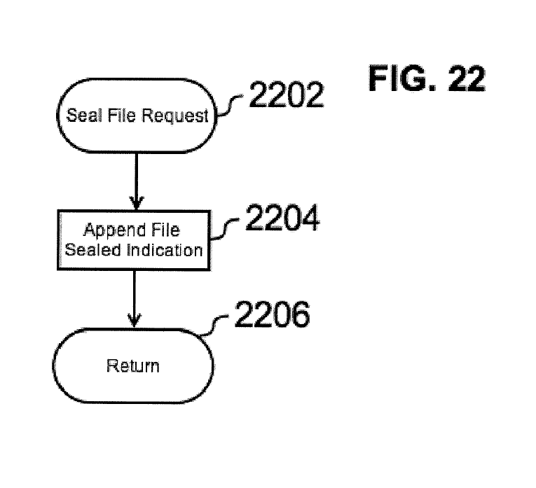

FIG. 22 is a flow chart illustrating aspects of an example automated method 2200 of receiving a seal file request at 2202 and appending a file sealed indication to the file at 2204 and returning in 2206.

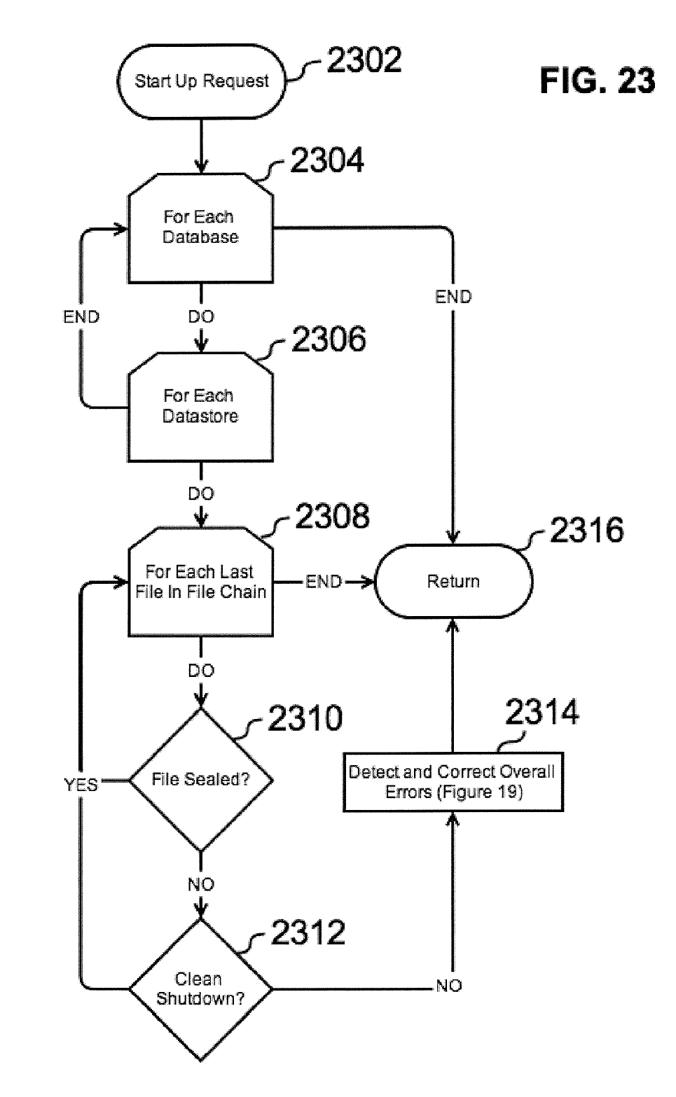

FIG. 23 is a flow chart illustrating aspects of an example automated method 2300 of receiving a start up request at 2302 and iterating over each database at 2304. Once all databases have been iterated over at 2304 the method returns at 2316.

For each database iterated over in 2304 the datastores within that database are iterated over at 2306 and the last file in each file chain is iterated over in 2308. Each last file is checked to determine if it is sealed in 2310 and if it is iteration continues at 2308. If the file is not sealed it is checked for clean shutdown indication in 2312 and if a clean shutdown has been performed iteration continues at 2308.

When a clean shutdown is not indicated at 2312 an error may be present and overall errors are detected and corrected at 2314. Additional details are described in connection with FIG. 19. After overall error detection and correction the method returns at 2316.

While aspects of this invention have been described in conjunction with the example aspects of implementations outlined above, various alternatives, modifications, variations, improvements, and/or substantial equivalents, whether known or that are or may be presently unforeseen, may become apparent to those having at least ordinary skill in the art. Accordingly, the example illustrations, as set forth above, are intended to be illustrative, not limiting. Various changes may be made without departing from the spirit and scope hereof Therefore, aspects of the invention are intended to embrace all known or later-developed alternatives, modifications, variations, improvements, and/or substantial equivalents.

What is claimed is:

1. A computer assisted method for error detection and correction in append-only data-stores, the method including:
receiving a user or agent input;
beginning error detection and correction involving at least one datastore based on the user or agent input;
creating an error detection and correction state;
performing error detection and correction;
interpreting at least one of a file sealing indication and a clean shutdown indication;
ending the error-detection and correction; and
writing the state of the error-detection and correction to memory in an append-only manner.

2. The method of claim 1 wherein the state comprises at least one selected from a group consisting of error-detection and correction indication and erasure code.

3. The method of claim 1, wherein the state comprises error-detection and correction indication and erasure code.

4. The method of claim 1, further comprising:
updating the error and correction state; and
maintaining the error and correction state.

5. The method of claim 1, wherein the error-detection and correction state is represented in an encoded state by at least one selected from a group consisting of an append-only transaction log, key, value and schema files.

6. The method of claim 5, wherein the memory is disk memory.

7. The method of claim 1, wherein beginning the error-detection and correction further includes accessing at least one file within the datastore to perform error detection and correction within the file.

8. The method of claim 7, wherein error detection and correction within the file includes file header error detection and correction.

9. The method of claim 8, wherein header error detection further comprises:
header length decoding and validation;
optional header CRC and CRC validation; and
header content validation.

10. The method of claim 8, wherein header error correction further comprises:
header length detection;
header regeneration; and
file regeneration.

11. The method of claim 7, wherein error detection and correction within a file includes record validation.

12. The method of claim 11, wherein the records are of a fixed size.

13. The method of claim 11, wherein the records are variable sized.

14. The method of claim 11, wherein record validation includes data consistency and CRC checks.

15. The method of claim 7, wherein error detection and correction within a file includes segment validation.

16. The method of claim 15, wherein the segments are variable sized.

17. The method of claim 15, wherein segments are compressed.

18. The method of claim 15, wherein segment validation includes at least one selected from a group consisting of decompression, data consistency and CRC checks.

19. The method of claim 7, wherein error detection and correction within a file includes frame validation.

20. The method of claim 19, wherein the frames are variable sized.

21. The method of claim 19, wherein frames are compressed.

22. The method of claim 19, wherein frame validation includes decompression, data consistency and CRC checks.

23. The method of claim 7, wherein error detection may be performed up to T Trials.

24. The method of claim 23, wherein error detection is performed on frames.

25. The method of claim 23, where error detection is performed on segments.

26. The method of claim 5, wherein the append-only transaction log, key, value and schema files encode state represent file sealing and clean shutdown.

27. The method of claim 26, further comprising:
appending clean shutdown codes to files to indicate a clean shutdown; and
appending file sealed codes to files to indicate file sealing.

28. The method of claim 26, wherein file sealing and clean shutdown codes include an additional state used during startup and error recovery.

29. The method of claim 28, further comprising:
including metadata comprising at least one selected from a group consisting of cardinality and statistical aggregations in index files; and
including at least one selected from a group consisting of indexing and summary indexing in index files

30. The method of claim 7, wherein error detection and correction within a file further comprises interpreting at least one selected from a group consisting of a file sealing indication and clean shutdown indication.

31. The method of claim 30, further comprising:
using clean shutdown and file sealing codes during startup; and
using an absence of the clean shutdown indication and the file sealing indication in order to identify a potential error.

32. The method of claim 1, wherein error correction includes record erasure.

33. The method of claim 32, wherein record erasure is achieved through the use of append-only erasure codes.

34. The method of claim 32, wherein record erasure is achieved through write cursor adjustment including cursor rewind.

35. The method of claim 1, further comprising performing an overall error detection and correction, wherein an overall error detection and correction includes correcting related database, datastore, transaction log, state log, index and schema files.

36. The method of claim 1, wherein a shutdown request causes a clean shutdown indication to be appended to all files modified since a last shutdown.

37. The method of claim 1, wherein a seal file request causes a file sealed indication to be appended to a file being sealed.

38. The method of claim 1, wherein a start up request initiates a fast error detection process that checks each database, each datastore, and all contained files for at least one of a sealed status and a clean shutdown status.

39. An automated system for error detection and correction in append-only data-stores, the system comprising:
means for receiving a user or agent input;
means for beginning error detection and involving at least one datastore based on the user or agent input;
means for updating and maintaining an error detection state;
means for correcting detected errors; and
means for writing the error detection and correction state to memory in an append-only manner.

40. The automated system of claim 39, wherein the error detection and correction state comprises append-only transaction logs, key, value and schema files.

41. A computer program product comprising a computer readable medium having control logic stored therein for causing a computer to perform error detection and correction in append-only data-stores, the control logic comprising code for:
receiving a user or agent input;
beginning error detection and correction involving at least one datastore based on the user or agent input;
updating and maintaining an error detection and correction state;
ending the error detection and correction; and
writing the state of the error detection and correction to memory in an append-only manner.

42. The computer program product of claim 41, wherein the error detection and correction state comprises append-only transaction logs, key, value and schema files.

43. An automated system of error detection and correction in append-only data-stores, the system comprising:
at least one processor;
a user interface functioning via the at least one processor, wherein the user interface is configured to receive a user input; and
a repository accessible by the at least one processor; wherein the at least one processor is configured to:
begin a transaction involving at least one datastore based on the user input;
update and maintain an error detection and correction state;
end the error detection and correction; and
write the state of the error detection and correction to memory in an append-only manner.

44. The automated system of claim 43, wherein the error detection and correction state comprises append-only transaction log, key, value and schema files.
